(19) United States
(12) Patent Application Publication
(10) Pub. No.: US 2013/0051257 A1
(43) Pub. Date: Feb. 28, 2013

(54) Scheduling of Packets at Cellular Base Stations

(71) Applicants: Vasileios Pappas, Yorktown Heights, NY (US); Dinesh Verma, Yorktown Heights, NY (US)

(72) Inventors: Vasileios Pappas, Yorktown Heights, NY (US); Dinesh Verma, Yorktown Heights, NY (US)

(73) Assignee: International Business Machines Corporation, Armonk, NY (US)

(21) Appl. No.: 13/222,885

(22) Filed: Aug. 31, 2011

(51) Int. Cl. H04W 72/04; H04W 24/00

(52) U.S. Cl. 370/252; 370/329

(57) ABSTRACT

A method for scheduling a sequential transmission of a plurality of packets includes estimating a time when each of the plurality of packets waiting to be transmitted will be used by a device targeted to receive the plurality of packets, and mapping the time of each of the plurality of packets to a prioritization among the plurality of packets.

### BACKGROUND

1. Technical Field

The present application relates to scheduling packets and more particularly to the scheduling of packets at a cellular base station.

2. Discussion of Related Art

The wireless spectrum at a cellular base station is a constrained resource. Data transmitted from the base-stations to the user-handhelds contends for this scarce resource. Current scheduling paradigms for packets on the wireless networks are not able to take into account the characteristics of the user-traffic since the IP level data traffic is encrypted and hidden underneath many different levels. However, when caching solutions are introduced at the base-stations, one can exploit information about user experience and user content to do more efficient scheduling of packet transmission.

Therefore, a need exists for scheduling packets at a cellular base station.

### BRIEF SUMMARY

According to an exemplary embodiment of the present disclosure, a method for scheduling a sequential transmission of a plurality of packets includes estimating a time when each of the plurality of packets waiting to be transmitted will be used by a device targeted to receive the plurality of packets, and mapping the time of each of the plurality of packets to a prioritization among the plurality of packets.

According to an exemplary embodiment of the present disclosure, a method for scheduling a sequential transmission of a plurality of packets includes determining a content type in the plurality of packets, selecting a User Time to Use (UTU) metric based on a determination of context type, determining a value of the UTU metric for each of the plurality of packets, and transmitting a next packet of the plurality of packets based on the values of the UTU metric.

According to an exemplary embodiment of the present disclosure, packet scheduling computer system includes a processor configured to perform a scheduling of a sequential transmission of a plurality of packets by estimating a time when each of the plurality of packets will be used by a device targeted to receive the plurality of packets and mapping the time of each of the plurality of packets to a prioritization among the plurality of packets, and a memory configured to store the prioritization.

### BRIEF DESCRIPTION OF THE SEVERAL VIEWS OF THE DRAWINGS

Preferred embodiments of the present disclosure will be described below in more detail, with reference to the accompanying drawings:

FIG. 1 is an exemplary system supporting scheduling of packet data at a cellular base station according to an embodiment of the present disclosure;

FIG. 2 is a flow chart of an exemplary method for scheduling of packet data according to an embodiment of the present disclosure;

FIG. 3 is an exemplary system for scheduling of packet data according to an embodiment of the present disclosure.

### DETAILED DESCRIPTION

According to an exemplary embodiment of the present disclosure, packet based communications, e.g., IP (Internet Protocol) packets on a GSM (Global System for Mobile Communications) network, may be scheduled according to packet content. By examining the packet content, a metric is determined for each packet. The metric is referred to herein as a User Time to Use (UTU).

The UTU metric is an amount of time after transmission of a packet from a base station that a target receiver of the packet will be able to consume the packet. The UTU metric is implemented as a prioritization criteria for packet scheduling. The prioritization criteria may be implemented in a variety of packet scheduling schemes, e.g., Earliest Deadline First (EDF), priority queue or Weighted Round Robin.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the invention in the faun disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

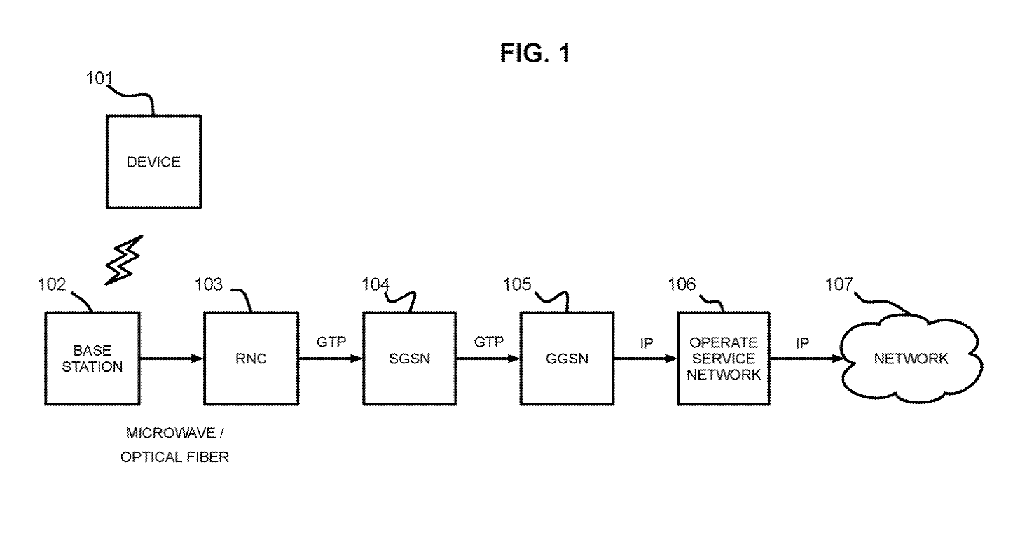

FIG. 1 shows an exemplary structure of different communication channels a 3GPP (3rd Generation Partnership Project) network supporting packet data communications. In FIG. 1, packet data communicated between a device 101, e.g., a cellular telephone, and a Radio Network Controller (RNC) 103 is encrypted using a set of keys established during connection setup. The set of keys are exchanged and obtained by a Serving GPRS Support Node (SGSN) 104 during an initial set-up of a communication protocol. The Base Station (BS) 102 relays packets between the device 101 and the RNC 103. The RNC 103 acts as a traffic concentration point, and the SGSN 104 provides initial control and security. The packets may be tunneled using any of a variety of protocols, e.g., GPRS Tunneling Protocol (GTP), between the device 101 and the SGSN 104. Any services provided by an operator of the network 107 are handled in the operate service network 106.

The bandwidth between the device 101 and a BS 102 may be limited due to restrictions on the wireless spectrum. As a result, data transmissions can build up on a wireless link between the device 101 and BS 102, for example, when the wired network between the BS 102 and RNC 103 (and other elements) is faster than the wireless connection between the BS 102 and the device 101.

The BS 102 may be embodied as a general-purpose server having memory to store packets and one or more processors for processing packets. Referring to FIG. 4, the BS 102 may be embodied as specialized hardware including, for example, a memory buffer (307) at a network interface (NIC) (308) and a hardware accelerator (309) for performing pattern matching, data parsing (HTML/XML parsing, MPEG4 parsing, etc.), compression/decompression, and the like.

According to an exemplary embodiment of the present disclosure, a scheduling scheme prioritizes packets for transmission based on the UTU metric for each packet. The UTU metric considers the type of content in each packet. For example, for streaming media (e.g., streaming voice or video), the UTU metric is an amount data, e.g., measured in play-time, buffered at the device 101 ahead of data already played at the device 101. For downloaded media (e.g., file transfer), the UTU metric is a number of bytes remaining to download divided by a download rate, e.g., Mbs (megabits per second) (e.g., the UTU metric may be a time when a last byte of a file is expected to be delivered to the device 101). For other TCP (Transmission Control Protocol) transferred content (e.g., web-pages), the UTU metric is an amount of information that is currently in flow-control buffers of the device 101 for a current session. Equivalent definitions for other classes of traffic may be readily created in view of the present disclosure.

The UTU is determined in the context of an access point that supports a capability such as DPI (Deep Packet Inspection). Any part of a packet may be inspected using, for example, header look ups (e.g., IP addresses, TCP/UDP port numbers, HTTP headers). DPI includes inspecting payload data of a packet. The payload data typically follows the protocol headers in a packet. DPI may also inspect and correlate data across multiple packets belonging to the same end-to-end flow (e.g., packets having the same address/port number tuples). As such, DPI may be implemented to keep a state for some of the packets, even if the packets are not present in the BS 102.

With DPI, and by examining application-level flows, the UTU metric can be determined or estimated. For example, assume a user is downloading a video file from a web server. If after T seconds from the beginning of the video download, the video player (e.g., the HTTP browser or the flash player) has downloaded Tₚ seconds worth of video, then the UTU is Tₚ minus T, which may be written as Tₚ−T. In a different example, if after T seconds of download the base-station knows, with the use of DPI techniques, that the user is watching the video at time Tᵤ, then the UTU is Tₚ minus Tᵤ, which may be written as Tₚ−Tᵤ.

Once the UTU metric is determined for a packet, it can be mapped to a prioritization of packets in a packet scheduling method. Exemplary mappings include EDF scheduling, priority queue and weighted round robin queues.

EDF scheduling uses the UTU metric as a deadline. That is, in the EDF scheduling, when a scheduling event occurs (e.g., a task finishes, a new task is released, etc.) a queue is searched for a packet closest to its deadline. The packet closest to its deadline is selected as a next packet to be scheduled for transmission.

The priority queue method uses the UTU metric to map packets into one of N priority queues. The priority for longer UTU metrics is relatively small as compared to shorter UTU metrics.

Weighted round robin queues may use an average UTU metric of a plurality of packets in a given queue to determine weights for a round-robin scheduling.

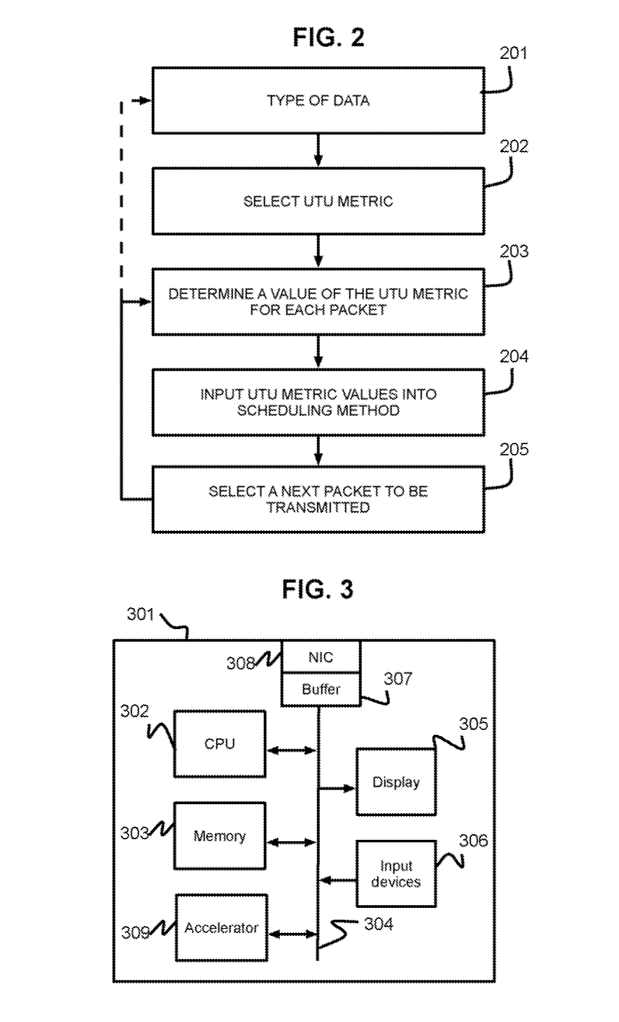

Referring to FIG. 2, an exemplary method for scheduling packet data includes determining a content type in the packet data at block 201 and selecting a UTU metric based on the determination of context type at block 202. At block 203, a value of the UTU metric is determined for each packet. A value of the UTU metric for each packet is input into an appropriate scheduling method at block 204 and the scheduling method selects a next packet to be transmitted from a plurality of packets waiting to be transmitted based on the UTU metric values at block 205. The method continued to determine values for each packet created for transmission at block 203. Alternatively, the method may determine the type of data for each newly created packet at block 201.

The methodologies of embodiments of the invention may be particularly well-suited for use in an electronic device or alternative system. Accordingly, embodiments of the present disclosure may take the form of an entirely hardware embodiment or an embodiment combining software and hardware aspects that may all generally be referred to herein as a “processor”, “circuit,” “module” or “system.” Furthermore, embodiments of the present disclosure may take the form of a computer program product embodied in one or more computer readable medium(s) having computer readable program code stored thereon.

Any combination of one or more computer usable or computer readable medium(s) may be utilized. The computer-usable or computer-readable medium may be a computer readable storage medium. A computer readable storage medium may be, for example but not limited to, an electronic, magnetic, optical, electromagnetic, infrared, or semiconductor system, apparatus, device, or any suitable combination of the foregoing. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus or device.

Computer program code for carrying out operations of embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present disclosure are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions.

These computer program instructions may be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

For example, FIG. 3 is a block diagram depicting an exemplary system for scheduling packet data, e.g., a BS 102. The system 301 may include a processor 302, memory 303 coupled to the processor (e.g., via a bus 304 or alternative connection means), as well as input/output (I/O) circuitry 305-306 operative to interface with the processor 302. The processor 302 may be configured to perform one or more methodologies described in the present disclosure, illustrative embodiments of which are shown in the above figures and described herein.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to more than one processing device, and that various elements associated with a processing device may be shared by other processing devices. The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., printer, monitor, etc.) for presenting the results associated with the processor.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although illustrative embodiments of the present disclosure have been described herein with reference to the accompanying drawings, it is to be understood that the invention is not limited to those precise embodiments, and that various other changes and modifications may be made therein by one skilled in the art without departing from the scope of the appended claims.

What is claimed is:

1. An computer program product for scheduling a sequential transmission of a plurality of packets, the computer program product comprising:
a computer readable storage medium having computer readable program code embodied therewith, the computer readable program code comprising:
computer readable program code configured to estimate a time when each of the plurality of packets waiting to be transmitted will be used by a device targeted to receive the plurality of packets; and
computer readable program code configured to map the time of each of the plurality of packets to a prioritization among the plurality of packets.

2. The computer program product of claim 1, further comprising computer readable program code configured to determine a content type of the plurality of packets.

3. The computer program product of claim 1, further comprising computer readable program code configured to determine a content type of each of the plurality of packets.

4. The computer program product of claim 3, wherein the content type is determined by inspecting a payload of the each of the plurality of packets.

5. The computer program product of claim 1, further comprising computer readable program code configured to select a metric for estimating the time based on a content type of the plurality of packets.

6. The computer program product of claim 5, further comprising computer readable program code configured to determine a value for each of the plurality of packets according to the metric selected for estimating the time.

7. The computer program product of claim 5, further comprising computer readable program code configured to measure an amount data buffered at the device ahead of data already played at the device.

8. The computer program product of claim 5, further comprising computer readable program code configured to measure an amount of data at flow-control buffers of the device for a current session.

9. The computer program product of claim 1, further comprising computer readable program code configured to select a next packet to be transmitted from the plurality of packets based on the prioritization.

10. The computer program product of claim 1, wherein a content type of at least one packet of the plurality of packets is streaming data.

11. The computer program product of claim 1, wherein a content type of at least one packet of the plurality of packets is file transfer.

12. The computer program product of claim 1, wherein a content type of at least one packet of the plurality of packets is Transmission Control Protocol content.

13. The computer program product of claim 1, wherein the prioritization is mapped according to one of an earliest deadline first scheduling, priority queue and weighted round robin queues.

14. An computer program product for scheduling a sequential transmission of a plurality of packets, the computer program product comprising:
a computer readable storage medium having computer readable program code embodied therewith, the computer readable program code comprising:
computer readable program code configured to determine a content type of the plurality of packets;
computer readable program code configured to select a User Time to Use (UTU) metric based on the determination of the content type;
computer readable program code configured to determine a value of the UTU metric for each of the plurality of packets; and
computer readable program code configured to transmit a next packet of the plurality of packets based on the values of the UTU metric.

15. The computer program product of claim 14, wherein determining the content type of the plurality of packets further comprises determining a content type of each of the plurality of packets.

16. The computer program product of claim 14, wherein determining the content type of the plurality of packets further comprises inspecting a payload of each of the plurality of packets.

17. The computer program product of claim 14, further comprising computer readable program code configured to select the next packet to be transmitted from the plurality of packets based on a priority determined according to the values of the UTU metric.

18. The computer program product of claim 14, wherein the UTU metric measures an amount data buffered at a device receiving the plurality of packets ahead of data already played at the device.

19. The computer program product of claim 14, further comprising computer readable program code configured to measure a number of bytes remaining to download divided by a download rate when the content type is file transfer.

20. The computer program product of claim 14, further comprising computer readable program code configured to measure an amount of data at flow-control buffers of a device receiving the plurality of packets for a current session when the content type is Transmission Control Protocol content.

21. A packet scheduling computer system comprising:
a processor configured to perform a scheduling of a sequential transmission of a plurality of packets by estimating a time when each of the plurality of packets will be used by a device targeted to receive the plurality of packets and mapping the time of each of the plurality of packets to a prioritization among the plurality of packets; and
a memory configured to store the prioritization.

22. The system of claim 21, wherein the processor selects a metric for estimating the time based on a content type of the plurality of packets.

23. The system of claim 21, further comprising a communication channel connecting the system to a network.

24. The system of claim 21, further comprising an encrypted communication channel connecting the system to a radio network controller.

25. The system of claim 21, further comprising a wireless communication channel connecting the system to the device.
